(19) United States
(12) Patent Application Publication
(10) Pub. No.: US 2001/0039251 A1
(43) Pub. Date: Nov. 8, 2001

(54) REMOVAL OF SCREENING PASTE RESIDUE WITH QUATERNARY AMMONIUM HYDROXIDE-BASED AQUEOUS CLEANING COMPOSITIONS

(76) Inventors: KRISHNA G. SACHDEV, HOPEWELL JUNCTION, NY (US); JAMES N. HUMENIK, LAGRANGEVILLE, NY (US); JOHN U. KNICKERBOCKER, HOPEWELL JUNCTION, NY (US); GLENN A. POMERANTZ, KERHONKSON, NY (US)

Correspondence Address: AZIZ M AHSAN, INTELLECTUAL PROPERTY LAW, IBM CORPORATION, 1580 ROUTE 52, HOPEWELL JUNCTION, NY, 125336531

(21) Appl. No.: 09/096,840

(22) Filed: Jun. 12, 1998

(51) Int. Cl. C11D 17/08

(52) U.S. Cl. 510/177; 510/415

(57) ABSTRACT

This invention relates to cleaning organic polymer-metal composite material from screening masks and associated accessories used for printing a conductive paste pattern on microelectronic components, such as, for example, ceramic green sheets in the production of semiconductor packaging substrates. More particularly, this invention is concerned with the aqueous cleaning of screening paste residue from masks and other paste screening and processing equipment using water-based alkaline cleaning compositions comprising an organic quaternary ammonium hydroxide as the primary basic active ingredient to provide a more environmentally friendly alternative to non-aqueous organic solvents-based cleaning.

### FIELD OF THE INVENTION

This invention relates to cleaning organic polymer-metal composite materials from screening masks and associated accessories used in printing conductive paste patterns on ceramic green sheets in the production of substrates for semiconductor packaging. More particularly, this invention is concerned with the aqueous cleaning of screening paste residue from masks and other screening equipment using water-based alkaline cleaning compositions comprising an organic quaternary ammonium hydroxide as the primary basic active ingredient to provide a more environmentally friendly alternative to non-aqueous organic solvents based cleaning.

### BACKGROUND OF THE INVENTION

In the fabrication of multilayer ceramic (MLC) substrates for packaging semiconductor devices, conductive metal patterns are screened onto individual ceramic green sheets through a mask, such as, a metal mask. This screening can be done, such as, by extrusion printing using at least one nozzle, or by screen printing through an emulsion mask employing a non-pressurized paste squeegee method, etc. After screening, the green sheets are assembled and aligned, laminated and then sintered.

The fabrication processes and equipment used to produce multilayer ceramic packages with paste-screened internal metallization are well known in the art.

However, the fabrication of advanced ground rule electronic packaging structures requires the printing of closely spaced conductive metal patterns utilizing metal masks that have a high density of fine pitch etched features. It has been observed that in the case of the masks having closely spaced features, there is a problem with paste residue build-up in and around the mask features in addition to the residue on the top and bottom surface of mask. This requires that the masks, especially the metal masks be cleaned after one or more screening passes to remove such residue to eliminate/minimize the possibility of defects in subsequently screened patterns, thereby preventing product yield loss. Furthermore, removing paste residue on masks is more critical in the case of finer pitch etched features.

Conductive pastes used in screening processes for the delineation of wiring and via metallurgy pattern or for use in the application of solder-based paste patterns onto electronic components, basically comprise metal particles dispersed in an organic binder and solvent vehicle along with wetting agents, dispersants/surfactants, plasticizers, and other additives as rheology modifiers, thickening agents, antioxidants, and coloring agents which are all well known ingredients in paste compositions for the fabrication of electronic components.

Additionally, selection of conductive screening pastes which are based on a variety of metal/polymer binder/solvent vehicle systems is dictated by several considerations, viz, the requirement for a particular circuit pattern, the drying characteristics of the paste, the match of paste shrinkage with that of the ceramic, and the overall compatibility of the paste with the green sheet materials, to name a few.

The most commonly used conductive pastes in multilayer ceramic fabrication are based on molybdenum or tungsten metal powder dispersed in an organic binder, such as, for example, ethyl cellulose, polymethylmethacrylate and the like, or polyhydrocarbon based thermoplastic resins in a high boiling organic solvent vehicle. Other conductive paste types employed in multilayer ceramics can be based on copper, gold or nickel as the metal constituent. Because of the variety and complex chemical make-up of polymer/metal dispersions, it is required that the mask cleaning medium and process selected be such that it provides complete and efficient cleaning of paste residue on masks and associated equipment regardless of the paste characteristics in terms of wettability, solubility, polarity, etc.

Recently, several water-based cleaners have become commercially available and many aqueous detergent compositions have been described in the patent literature, for example, for cleaning laboratory glassware, and printed circuit board assemblies to remove soldering flux, oil/grease, and other organic residues invariably formed during bonding and assembly processes. These are generally based on a combination of surfactants in water and/or alkaline detergent compositions comprising alkali metal salts as sodium metasilicate, sodium carbonate, tribasic sodium phosphate, sodium tripolyphosphate, and combinations thereof, and highly alkaline solutions based on alkali metal salts, alkali metal hydroxides, and mixtures thereof with alkanolamines; and microemulsion cleaners comprising an aqueous solution of surface active agents with detergent compositions and a water-insoluble organic solvent.

U.S. patent spplication Ser. No.______ , filed on May ______, 1998, Attorney Docket No. FI9-97-244, entitled “AQUEOUS QUATERNARY AMMONIUM HYDROXIDE AS A SCREENING MASK CLEANER”, assigned to the assignee of the instant Patent Application, and the disclosure of which is incorporated herein by reference, discloses one such solution by using an aqueous quaternary ammonium hydroxide as a more environmentally friendly alternative to non-aqueous solvents for cleaning of masks, such as, a screening mask.

### PURPOSES AND SUMMARY OF THE INVENTION

The invention is a novel process for removing screening paste residue with aqueous, alkaline cleaning compositions based on quaternary ammonium hydroxide as the common active ingredient of these compositions.

Therefore, one purpose of this invention is to provide a method of cleaning paste screening masks and associated screening equipment using aqueous-based alkaline cleaning compositions.

Another purpose of this invention is to provide aqueous alkaline compositions based on organic quaternary ammonium hydroxide and a method of cleaning masks and other screening accessories with these compositions.

Yet another purpose of this invention is to provide an aqueous cleaning method using quaternary ammonium hydroxide based alkaline solution for removing paste residue from masks and other screening accessories which utilizes a minimum volume of cleaning solution, conserves water, and reduces waste.

Yet another purpose of this invention is to provide an aqueous cleaning method for paste screening masks where it is practical to recover metals from the solid waste.

Still yet another purpose of this invention is to provide an aqueous cleaning method using quaternary ammonium hydroxide-based compositions which have no detrimental effect on screening equipment including metal masks, emulsion masks, screening nozzles, squeegee blades, polymer adhesives used in mask assembly, cleaning tool contacting surfaces, etc.

Therefore, in one aspect this invention comprises a composition for removing at least a portion of a screening paste residue from at least one paste screening object with at least one aqueous alkaline composition comprising at least one quaternary ammonium hydroxide as at least one component of said composition.

In another aspect this invention comprises a cleaning apparatus comprising:

(a) at least one means for immersing at least one screening object having screening paste residue on said screening object in at least one container;

(b) wherein said container comprises at least one aqueous alkaline composition having at least one quaternary ammonium hydroxide as at least one component of said composition;

(c) wherein said aqueous alkaline composition is subjected to at least one means of mechanical agitation;

(d) said at least one means of mechanical agitation also causes separation of at least a portion of said paste residue from said screening object; and

(e) at least one means of rinsing said screening object with water after cleaning with said aqueous alkaline solution, followed by at least one means of drying said screening object after said cleaning and rinsing operation.

In yet another aspect this invention comprises a cleaning apparatus comprising:

(a) at least one means for pressure spraying at least one solution onto at least one screening object having screening paste residue on said screening object; and

(b) wherein said at least one solution comprises at least one aqueous alkaline composition having at least one quaternary ammonium hydroxide as at least one component of said composition.

The features of the invention believed to be novel and the elements characteristic of the invention are set forth with particularity in the appended claims. The invention itself, however, both as to organization and method of operation, may best be understood by reference to the detailed description which follows:

### DETAILED DESCRIPTION OF THE INVENTION

This invention is concerned with a method of removing paste residue from screening masks and ancillary equipment used in screening conductive paste patterns on ceramic green sheets in the manufacture of multilayer ceramic substrates. This invention is particularly concerned with removing polymer-metal/inorganic paste residue from screening masks using aqueous cleaner compositions containing tetramethyl ammonium hydroxide and related organic quaternary ammonium hydroxides as such or in combination with additives for modifying wettability, specifically, surfactants and/or water soluble organic solvents, to provide a more environmentally friendly alternative to organic solvents.

The manufacture of semiconductor packaging products, such as multilayer ceramic substrates, typically employs the technique of conductive pattern screening onto ceramic green sheets through a mask, such as, a metal mask, using a variety of polymer/metal composite pastes to delineate conductive patterns for the desired circuitry. In this process, some paste residue accumulates in and around the fine pitch etched features of the mask, particularly on the underside, in addition to that on the surface of the mask. The entrapped residue must be removed if the mask is to be reused which involves cleaning after one or more screening passes depending on whether the paste is fast drying or slow drying as otherwise the residue can cause defects in subsequently screened conductive patterns. The particular combination of a polar and/or non-polar polymer binder and solvent vehicle system selected for dispersing the metal powder determines the solubility and wettability characteristics of the resulting paste which may range from hydrophilic to lipophilic and which may be fast drying or slow drying.

Selection of conductive screening pastes that are based on a variety of metal/polymer binder/solvent vehicle system is dictated by several considerations, viz., the requirement for a particular circuit pattern, drying characteristics, the match of paste shrinkage with that of the ceramic, and the overall compatibility of the paste with the green sheet materials for the necessary wettability and adhesion.

Screening masks are typically made of metal, such as, etched Mo masks, electroform masks, and emulsion masks for silk screening, such as, for example, stainless steel mesh with at least one photoresist coating of a suitable emulsion such as those based on polyvinyl alcohol-polyvinylacetate/polyacrylic-polyester type emulsion coatings.

The present invention provides a method for cleaning masks and other screening accessories using aqueous tetramethyl ammonium hydroxide-based alkaline cleaning compositions as a more environmentally friendly alternative to organic solvents for the effective cleaning of screening paste residue from masks and associated screening equipment regardless of the paste type.

Aqueous tetramethyl ammonium hydroxide (TMAH) is widely used in the semiconductor industry as a metal-ion-free resist developer in lithographic processes for integrated circuit device fabrication. Semi-aqueous cleaning compositions containing TMAH for removal of baked photoresist residues, and for cleaning semiconductor wafers and wafer carriers have been known. For example, U.S. Pat. No. 5,407,788 (Fang) describes the use of tetramethyl ammonium hydroxide (TMAH) in a non-aqueous solvent for stripping cured patterns of negative resist; U.S. Pat. No. 5,350,489 (Muraoka) is concerned with the use of quaternary ammonium hydroxide solutions for cleaning plastic molded items used in chemical analysis and wafer carriers to remove impurities of fine particles and fats and oils; and U.S. Pat. No. 5,466,389 (Ilardi) is concerned with cleaning silicon wafers using aqueous cleaning compositions having 8-10 pH comprising TMAH and related organic bases or alkali metal hydroxides in combination with surfactants, buffering agents for adjusting pH to less than 10; U.S. Pat. No. 4,592,856 (Kobayashi) is concerned with removing oil/grease and resinous contaminants from the surface of plastic articles and molding equipment for eye glass lenses and optical instruments using detergent compositions comprising TMAH or 2-hydroxyethyl trimethyl ammonium hydroxide (Choline) in chlorinated solvents as perchloroethylene, 1,1,1-trichloroethane, methylene chloride, an ionic/non-ionic surfactant and methyl alcohol.

As stated earlier, the polymer/metal pastes that are used for defining via and wiring metallurgy patterns on ceramic green sheets are comprised of metal constituents, such as, molybdenum, copper, tungsten, some may contain nickel, gold, palladium, platinum and silver, which may include inorganic fillers such as glass, ceramic powder, or glass frit, all dispersed in an organic polymer binder and a high boiling solvent vehicle along with additives including dispersants, rheological control agents as thickening agents suitable for a particular screening application, antioxidants, coloring agents, etc.

The invention may also be used to clean masks and screens which are used in the application of solder pastes for various microelectronic components.

Representative polymer binder systems for molybdenum paste include: cellulosic polymers, for example, ethylcellulose, acrylate polymers such as polymethymethacrylate, and polyhydrocarbon resins which are all hydrophobic, or the binder can be water soluble, for example, hydroxyethyl cellulose, hydroxypropyl cellulose, hydroxymethyl cellulose, carboxymethyl cellulose, and the like.

The preferred high boiling solvent vehicle having a low evaporation rate in paste dispersions are ester-alcohol and glycol-ether type solvents such as 2,2,4-trimethylpentane diol, 1,3, monoisobutyrate (Texanol), diethylene glycol monomethylether acetate, diethylene glycol monobutylether acetate or butyl carbitol acetate (BCA), and the like.

Depending on the solvent vehicle system used, the paste can be polar or non-polar, hydrophilic or lipophilic, and have differences in affinity and adhesive characteristics for a metal mask surface in addition to having differences in drying rate, which all affect the removal of paste residue by a particular cleaning medium.

According to this invention, it has been found that paste build-up in and around the mask features in the screening process can be readily removed by ultrasonic agitation in a heated aqueous alkaline solution comprising quaternary ammonium hydroxide, specifically, tetramethyl ammonium hydroxide (TMAH) as one of the active ingredients which may contain surface tension lowering additives, for example, surfactants and/or water soluble organic solvents, alkali metal hydroxide and alkali metal salts, and optionally one or more corrosion inhibitor. Minimum effective pH for the quaternary ammonium hydroxide-based aqueous cleaning solutions described here is greater than 11.5, preferably between about 11.9 and about 12.9.

The exact paste composition is not critical, any residue from screening pastes comprising electrically and/or thermally conductive ingredients in an organic polymeric binder and an organic solvent vehicle along with dispersing agent can be cleaned according to the method described here.

Ultrasonic cleaning is preferred over a spray wash as a multiple number of masks can be cleaned simultaneously in the same solution providing waste minimization, cost benefit, and reduction in water consumption. Although other means of mechanical agitation and pressurized spray also provide effective cleaning, these are not found suitable with surfactant carrying compositions even when the surfactant added is a low-foam type because of foam formation, which dampens the mechanical impact of pressurized spray.

In another embodiment of this invention, TMAH-based aqueous alkaline cleaning solutions may include alkali metal hydroxide such as sodium hydroxide, potassium hydroxide and/or alkali metal salts, such as, sodium carbonate, sodium sesquicarbonate, and/or potassium carbonate. These solutions may also include alkali metal silicates, for example, sodium silicate, potassium silicate, and/or sodium phosphate, sodium tripolyphosphate as detergency enhancing additives, and optionally one or more corrosion inhibitors.

Aqueous cleaning compositions comprising TMAH in conjunction with a non-ionic surfactant and/or a water soluble environmentally suitable organic solvent are especially effective with the ultrasonic cleaning of heavy paste residue from extrusion heads, paste nozzles, paste applicators, and other screening accessories.

Various quaternary ammonium hydroxides preferred for aqueous alkaline cleaning solutions according to this invention include: tetramethyl ammonium hydroxide, tetraethyl ammonium hydroxide, tetrabutyl ammonium hydroxide, trimethyl-2-hydroxyethyl ammonium hydroxide (Choline), triethyl-2-hydroxy ethyl ammonium hydroxide, ethyltrimethyl ammonium hydroxide, methyl tri-(2-hydroxyethyl) hydroxide and the like. These solutions may also include organic amine bases such as those selected from the group alkanolamines, for example, 2-ethanolamine, diethanolamine, 1-amino-2-propanolamine, and the like.

Water soluble organic solvents selected for blending with TMAH-based aqueous solutions for paste residue removal are presently exempt from environmental regulations, particularly these solvents are not in the category of Hazardous Air Pollutants nor are these among the SARA Title-III reportable compounds or suspected carcinogens.

Representative solvent candidates suitable for the purpose of this invention include: dipropylene glycol alkyl ethers, for example, dipropylene glycol monomethyl ether, dipropylene glycol monobutyl ether, tripropylene glycol monomethyl ether, 3-methoxy-1-butanol, benzyl alcohol, and the like.

Surfactants which may optionally be added to aqueous alkaline solutions for example are non-ionic surfactants selected from the group, comprising low foam linear long chain alcohol ethoxylates, typically, dodecyl alkyl ethoxylates, nonylphenoxy poly(ethyleneoxy) ethanol, octyl phenoxy-polyoxy ethanol; EO/PO polymers, such as, polyoxyethylene-polyoxypropylene block co-polymers at varying composition of EO/PO blocks; fluorinated polyoxyethylene alkanols, such as, Fluorad 171; and alkyl polyglycosides surfactants, for example, D-glucose-decyloctyl polyether ether oligomers. These surfactants are well known in the art and are commercially available as concentrates in a polypropylene glycol or polyethylene glycol-water mixture. In addition to these, ionic and amphoteric surfactants, defoamers and corrosion inhibitors may also be added if needed.

Unless specified otherwise, the percentages given in this patent application are in vol % (volume percent) and in wt % (weight percent).

According to one preferred embodiment of this invention, quaternary ammonium hydroxide-containing aqueous solutions that are effective in cleaning paste residue from screening masks and associated equipment comprise the following:

(a) An aqueous solution of tetramethyl ammonium hydroxide (TMAH) having between about 0.5 to about 5 wt % TMAH based on (CH3)₄N⁺OH⁻ as the active ingredient.

(b) The aqueous TMAH solution described in (a) additionally comprising a non-ionic surfactant of low foam type as long chain alcohol ethoxylates, ethoxylated alkyl phenols such as octylphenoxy polyoxyethanol, and ethylene oxide/propylene oxide block co-polymers, and glucose based alkyl polyethers or alky polyglycosides which to a large extent are biodegradable.

(c) An aqueous alkaline solution comprising tetramethyl ammonium hydroxide, 2-hydroxyethyl trimethyl ammonium hydroxide (Choline), tetraethyl ammonium hydroxide, and combinations thereof, at a concentration of less than 1 wt % additionally comprising an alkali metal hydroxide, for example potassium hydroxide, sodium hydroxide, and mixture thereof, and/or alkali-metal silicate, for example, sodium metasilicate, potassium metasilicate, sodium tripolyphosphate, and the like; and/or an alkanolamine, for example, 2-aminoethanol, at a concentration of less than about 1 wt %, the mixture may also contain a surfactant.

(d) The aqueous TMAH solution described in (a) additionally comprising between about 10 to about 30 vol. % of a high boiling and water soluble organic solvent, preferably dipropylene glycol monomethyl ether and/or tripropylene glycol monomethyl ether.

A representative process for mask cleaning according to this invention involves immersing the masks having paste residue, in an aqueous TMAH-based alkaline solution pre-heated at between about 130° F. to about 170° F. and ultrasonically agitating the same for between about 30 to about 60 seconds, rinsing immediately with water, preferably hot deionized water in an ultrasonic bath or using pressurized spray and drying with forced air, or N₂, preferably hot air or nitrogen. When using an ultrasonic or spray rinse, rapid drying of the masks may be accomplished by a dip treatment or exposure to a fine mist of a lower boiling solvent, such as, isopropyl alcohol, or simply exposure to its vapor after the water rinse and then air dried.

The aqueous cleaning compositions described above which are comprised of a combination of TMAH and sodium hydroxide, potassium hydroxide and/or an organic amine have the advantage of reducing the TMAH concentration without affecting the cleaning performance. A similar reduction in TMAH concentration is obtained by adding between about 10 and about 30 vol % dipropylene glycol methyl ether (DPM) and/or tripropylene glycol methyl ether (TPM), and related water soluble high boiling organic solvents.

It has been found, unexpectedly, that the conductive metal from the removed paste essentially completely settles at the bottom of the ultrasonic tank and as such can be quantitatively recovered as a powdery material for recovery and reclamation.

An advantage of ultrasonic cleaning with these aqueous solutions is that a multiple number of masks can be arranged in a rack and cleaned simultaneously in the same bath solution which can be reused after filtering out the separated solids, thus providing material cost reduction, waste minimization, and the conservation of water. Similarly, screening accessories of all different sizes and shapes can be cleaned all together using an ultrasonic bath followed by a water rinse and a dry cycle.

According to this invention, an ultrasonic cleaning method is preferred when the cycle time requirement is not a factor, for example, in low volume production, and cleaning of screening accessories, such as, nozzles, squeegee blades, and paste residue removal from fragile stencil mask types where a pressure spray may cause damage to the mask integrity.

Major benefits of the aqueous cleaning method employing TMAH-based alkaline solutions include: no hazardous volatile emissions, no hazardous waste, no sludge treatment issues, low cleaner volume requirement, waste minimization, compatibility with cleaning accessories of all sizes and shapes, multiple mask cleaning with the same cleaning solution causing material cost reduction and minimizing water consumption.

It is preferred that the quaternary ammonium hydroxide is a tetraalkyl ammonium hydroxide selected from the group comprising tetramethyl ammonium hydroxide, tetraethyl ammonium hydroxide, trimethyl-2-hydroxyethyl ammonium hydroxide (Choline), tetrabutyl ammonium hydroxide, and combinations thereof.

The preferred aqueous alkaline composition based on quaternary ammonium hydroxide is aqueous tetramethyl ammonium hydroxide (TMAH) having a concentration in the range of between about 0.5 to about 5.0 weight percent based on (CH₃)₄N⁺OH⁻ solids dissolved in water, which may also contain a water soluble organic solvent.

However, the aqueous tetramethyl ammonium hydroxide (TMAH) solution could contain at least one non-ionic surfactant selected from the group comprising low foam long chain linear alcohol ethoxylates of the type poly(oxyethylene)dodecyl ether; ethoxylated alkyl phenols of the type octylphenoxy-polyethoxy ethanol, nonylphenoxy poly(ethyleneoxy) ethanol, and the like; and polyoxyethylene-polyoxypropylene block co-polymers, poly(oxyethylene-oxypropylene)nonyl phenyl ether, poy(oxyethylene)dodecyl ether; and polyalkyl glycosides of the type glucose-decyl-octyl ether oligomers, and combinations thereof.

The aqueous TMAH solution could also contain at least one alkali metal hydroxide, selected from sodium hydroxide, potassium hydroxide, and/or alkali metal salt selected from sodium carbonate, potassium carbonate, sodium metasilicate, sodium tripolyphosphate, and combinations thereof.

The aqueous TMAH solution could also contain at least one aliphatic amine selected from the group comprising monoethanolamine, diethanolamine, triethanolamine, and mixtures thereof. And, wherein the aliphatic amines could constitute between about 10 to about 30 percent of TMAH active ingredient concentration in deionized water to provide an aqueous cleaning solution with a pH in the range of between about 12.1 and about 13.1.

### EXAMPLES

Various aspects of the present invention are further illustrated by referring to the following examples which are intended only to further illustrate the invention and are not intended to limit the scope of the invention in any manner.

### Example 1

Molybdenum metal masks having fine etched features for via and wiring metallurgical patterns, and for I/O pads, suitable for multi-layer ceramic substrates were used for screening conductive pastes on ceramic green sheets with a screening tool. Various paste types screened on green sheets through metal masks are comprised of Mo, Cu, W, Ni as the metal component. The metal component was in the range of between about 60 to about 85 wt % as powder dispersed in between about 2 percent and 5 percent ethylcellulose or an alternative binder system such as polyhydrocarbon based thermoplastic polymer binder and a high boiling polar solvent of ester-alcohol type like 2,2,4-trimethylpentane diol 1,3-monoisobutyrate, glycol-ether type as diethylene glycol alkylether acetate, or a non-polar hydrocarbon oil.

Also included in the paste compositions are: thickening agents such as, for example, trigyceride fatty acid esters and dispersants/surfactants as alkyl sarcosinates, and other additives like antioxidants, coloring agents, corrosion inhibitors, etc. Paste compositions based on low molecular weight thermoplastic resins derived from petroleum hydrocarbons as the binder in conjunction with hydrocarbon oil as the solvent vehicle constituted lipophilic or non-polar paste types while the others are of polar type.

Some of the pastes tested contained an inorganic filler such as glass, ceramic, or glass frit in conjunction with a metal powder as the major component. After the paste screening operation, the masks carrying the paste residue on the surface, and in and around the etched features were cleaned with an aqueous tetramethyl ammonium hydroxide (TMAH)-based solution as described in the following sub-examples:

(a) Ultrasonic cleaning of paste residue with aqueous tetramethyl ammonium hydroxide (TMAH):

A 1.5 percent solution of TMAH was prepared by diluting about 300 cc of a 25 percent (wt. %) concentrate (based on (CH3)₄N⁺OH⁻) to about 5,000 cc with deionized water. The solution was heated to between about 140 and about 160° F. in an ultrasonic bath operated at a frequency of about 40 kHz. Mo metal masks having paste residue from the screening of Mo pastes including both the polar and non-polar type pastes were immersed in the heated cleaning solution and ultrasonically agitated for about 60 seconds followed by an immediate pressure spray rinse with hot deionized water at between about 110 and about 130° F., and forced air dry. Microscopic inspection of the cleaned masks showed a complete removal of residue from all areas of the mask regardless of the paste type used for screening.

Similarly, Electroform masks (Ni plated on an etched Cu foil) carrying residue from screening Cu and W pastes were cleaned within about 45 second using 1.0 percent TMAH solution at between about 140 to about 160° F. with ultrasonic agitation to provide complete removal of any residue from active and non-active areas of the masks. Similar results were obtained in the case of emulsion mask cleaning.

(b) Mask cleaning with aqueous TMAH-soluble organic solvent blend:

About a 0.7 percent (wt. %) solution of TMAH [based on (CH₃)₄N⁺OH⁻] prepared by diluting a 25 percent TMAH concentrate with an 85:15 (volume ratio) blend of deionized water and dipropyleneglycol monomethyl ether (DPM), respectively, was heated at between about 145 to about 160° F. in an ultrasonic bath operated at a frequency of about 40 kHz. Masks carrying paste residue from various types of pastes were stacked in a carrier and immersed in the heated aqueous cleaning solution, and ultrasonically agitated for between about 45 to about 60 seconds followed by an immediate spray rinse with deionized water and forced air dry. Microscopic examination of the masks after cleaning showed no evidence of residue on the surface or in the fine pitch etched features of the active area.

When 3-methoxy-1-butanol or tripropyleneglycol monomethyl ether (TPM) were used as a replacement of DPM or in combination with it, equally effective cleaning was accomplished under the same cleaning conditions. These organic solvent modified aqueous TMAH-based cleaning solutions were found to be effective for both the polar and non-polar paste residue in addition to providing a somewhat enhanced cleaning efficiency relative to the unmodified solution.

These solutions have no foaming problem and therefore can also be used with pressurized spray cleaning of emulsion masks at low pressure, for example, in the range between about 50 and about 70 psi. Since the emulsion masks are relatively fragile, ultrasonic cleaning or low pressure spray cleaning is preferred.

(c) Aqueous TMAH-based/low foam surfactant containing solution:

About 1 percent (wt. %) TMAH in deionized water was prepared by diluting a 25 percent TMAH concentrate in water to which was added about 0.05 percent (wt. %) of a low foam non-ionic surfactant, octyl phenoxy-polyethoxy ethanol (70 percent active) formulation in polyethylene glycol and water. The resulting solution was heated to between about 140 and about 170° F. in an ultrasonic bath and tested for mask cleaning using the process described in (a) above. It was found that the residue on metal masks and emulsion masks from the polar and non-polar pastes was effectively removed.

(d) Removal of paste residue on screening accessories:

Various forms of paste application equipment including disassembled nozzle components, and other paste handling items carrying dried paste residue were soaked in a heated aqueous TMAH-based/surfactant-containing solution described in (c) above, for between about 5 to about 10 min with ultrasonic off. The soak cycle was followed by ultrasonic agitation for between about 2 to about 3 min and an immediate water rinse, preferably deionized water, using an ultrasonic bath or a pressurized spray and a hot air dry, for example, using a dryer.

### Example 2

The following aqueous alkaline solutions comprising TMAH and having pH of between about 11.9 to about 12.9 were used for low pressure spray cleaning and ultrasonic cleaning. After the cleaning step, the masks were immediately spray rinsed with hot water and blow dried using nitrogen. Again, a highly effective and efficient removal of paste residue from all types of pastes was obtained from all areas of the masks including the fine line feature region of the active area:

(a) An aqueous solution comprising a blend of TMAH, sodium hydroxide (NaOH) and sodium carbonate (Na₂CO₃) was prepared such that the total concentration of active ingredients obtained was about 1.1 wt. percent comprising 0.6:0.2:0.3 wt. ratio of TMAH:NaOH:Na₂CO₃, respectively.

For mask cleaning, the solution was heated at between about 145 to about 155° F. and sprayed onto masks carrying residual paste from a prior screening pass, with a hand-held single nozzle set up at between about 60 to about 70 psi pressure for between about 35 to about 45 seconds followed by a spray rinse with deionized water at about 110° F., and blow dried using nitrogen. Microscopic inspection of the cleaned masks showed no evidence of residual paste on the mask. The same solution provided excellent cleaning with ultrasonic cleaning with the advantage that a much lower volume of cleaning solution was consumed due to the processing of multiple masks at one time and the repeated use of the same solution before it required replacing with a fresh solution.

(b) An aqueous solution comprising blend of TMAH and ethanolamine:

A cleaning solution was prepared having TMAH/ethanolamine with a total concentration of active ingredients of 1.1 percent and a relative ratio of about 9:2, respectively, for the two components. Mask cleaning with this solution using a pressurized spray and with ultrasonic agitation according to the process described above showed excellent cleaning of all types of pastes on all types of masks.

While the present invention has been particularly described, in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A composition for removing at least a portion of screening paste residue from a paste screening object with at least one aqueous alkaline composition comprising at least one quaternary ammonium hydroxide as at least one component of said composition.

2. The composition of claim 1, wherein said screening paste comprises at least one metal and/or inorganic particulate material, at least one polymeric binder and at least one solvent vehicle having at least one surfactant/dispersant and at least one thickening agent as additives, and optionally containing at least one antioxidant and at least one corrosion inhibitor.

3. The composition of claim 1, wherein said screening object is selected from a group consisting of a screening mask, a screening fixture, paste making equipment and processing equipment.

4. The composition of claim 1, wherein said screening object is selected from a group consisting of a metallic mask and an emulsion mask on a metal mesh.

5. The composition of claim 4, wherein material for said metal mesh is stainless steel.

6. The composition of claim 1, wherein said quaternary ammonium hydroxide is a tetraalkyl ammonium hydroxide selected from the group consisting of tetramethyl ammonium hydroxide, tetraethyl ammonium hydroxide, trimethyl-2-hydroxyethyl ammonium hydroxide (Choline), tetrabutyl ammonium hydroxide, and combinations thereof.

7. The composition of claim 1, wherein said aqueous quaternary ammonium hydroxide is tetramethyl ammonium hydroxide.

8. The composition of claim 1, wherein said quaternary ammonium hydroxide component of said aqueous alkaline composition is aqueous tetramethyl ammonium hydroxide (TMAH) having concentration in the range of between about 0.5 to about 5.0 weight percent based on (CH₃)₄N⁺OH⁻ solids dissolved in water.

9. The composition of claim 8, wherein said aqueous alkaline composition containing tetramethyl ammonium hydroxide (TMAH) also contains at least one non-ionic surfactant selected from the group consisting of low foam long chain linear alcohol ethoxylates of the type poly(oxyethylene)dodecyl ether; ethoxylated alkyl phenols of the type octylphenoxy-polyethoxy ethanol, nonylphenoxy poly(ethyleneoxy) ethanol, and the like; and polyoxyethylene-polyoxypropylene block co-polymers, poly(oxyethylene-oxypropylene)nonyl phenyl ether, poy(oxyethylene)dodecyl ether; and polyalkyl glycosides of the type glucose-decyl-octyl ether oligomers, and combination thereof.

10. The composition of claim 8, wherein said aqueous alkaline composition containing TMAH also contains between about 10 to about 30 volume percent of at least one high boiling water soluble organic solvent selected from the group consisting of benzyl alcohol, dipropylene glycol alkyl ethers, tripropylene glycol alkyl ethers, 3-methoxy-1-butanol, methoxy propanol, and mixtures thereof, and wherein said alkyl is selected from a group consisting of butyl, ethyl, methyl and propyl group, or said alkyl is a hydrocarbon radical selected from the group consisting of CₙH₂ₙ₊₁, where n=1-4.

11. The composition of claim 8, wherein said aqueous alkaline composition containing TMAH also contains at least one alkali metal hydroxide and/or at least one carbonate and/or at least one alkali metal silicate selected from a group consisting of sodium hydroxide, potassium hydroxide, and mixtures thereof, and/or sodium carbonate, sodium sesquicarbonate, sodium metasilicate, potassium metasilicate, sodium tripolyphosphate, and mixtures thereof.

12. The composition of claim 8, where said aqueous alkaline composition containing TMAH contains at least one aliphatic amine selected from the group consisting of monoethanolamine, diethanolamine, triethanolamine, and mixtures thereof.

13. The composition of claim 12, wherein said aliphatic amines constitute between about 10 to about 30 weight percent of TMAH active ingredient concentration in deionized water to provide aqueous cleaning solution.

14. The composition of claim 1, wherein said composition of removing screening paste residue from a paste screening object with aqueous alkaline composition comprising quaternary ammonium hydroxide as at least one component of said composition, comprises the steps of:
(a) immersing said screening object in at least one pre-heated cleaning solution at between about 130° F. to about 170° F. in an ultrasonic bath and subjecting to ultrasonic agitation in said pre-heated cleaning solution for between about 30 seconds and about 2 minutes,
(b) removing said screening object from said cleaning solution and immediately subjecting said screening object to at least one ultrasonic or spray rinse with water.

15. The composition of claim 14, wherein said water is preferably deionized water.

16. The composition of claim 14, wherein after step (b) said screening object is dried using air and/or nitrogen.

17. A cleaning apparatus comprising:
(a) at least one means for immersing at least one screening object having screening paste residue on said screening object in at least one container;
(b) wherein said container comprises at least one aqueous alkaline composition having at least one quaternary ammonium hydroxide as at least one component of said composition;
(c) wherein said aqueous alkaline composition is subjected to at least one means of mechanical agitation;
(d) said at least one means of mechanical agitation also causes separation of at least a portion of said paste residue from said screening object; and
(e) at least one means of rinsing said screening object with water after cleaning with said aqueous alkaline solution, followed by at least one means of drying said screening object after said cleaning and rinsing operation.

18. A cleaning apparatus comprising:
(a) at least one means for pressure spraying at least one solution onto at least one screening object having screening paste residue on said screening object; and
(b) wherein said at least one solution comprises at least one aqueous alkaline composition having at least one quaternary ammonium hydroxide as at least one component of said composition.
